(19) United States
(12) Patent Application Publication
(10) Pub. No.: US 2008/0179490 A1
(43) Pub. Date: Jul. 31, 2008

(54) SOLID-STATE IMAGE PICKUP DEVICE

(75) Inventors: Toshikazu OHNO, Mizuho-shi (JP); Tatsushi Ohyama, Ogaki-shi (JP); Tohru Watanabe, Ogaki-shi (JP)

Correspondence Address: DITTHAVONG MORI & STEINER, P.C., 918 Prince St., Alexandria, VA, 22314, US

(73) Assignee: SANYO ELECTRIC CO., LTD., Moriguchi-shi (JP)

(21) Appl. No.: 12/023,567

(22) Filed: Jan. 31, 2008

(30) Foreign Application Priority Data
Jan. 31, 2007 (JP) 2007-22324

(51) Int. Cl. G01J 1/20

(52) U.S. Cl. 250/201.1

(57) ABSTRACT

A solid-state image pickup device includes a plurality of optical sensors having different photosensitivity, wherein signals of the optical sensors having prescribed photosensitivity are read in response to object information.

### CROSS-REFERENCE TO RELATED APPLICATIONS

The priority application number JP2007-22324, Solid-State Image Pickup Device, Jan. 31, 2007, Toshikazu Ohno, Tatsushi Ohyama, Tohru Watanabe, upon which this patent application is based is hereby incorporated by reference.

### BACKGROUND OF THE INVENTION

1. Field of the Invention

The present invention relates to a solid-state image pickup device, and more particularly, it relates to a solid-state image pickup device comprising a plurality of optical sensors having different photosensitivity.

2. Description of the Background Art

A solid-state image pickup device comprising a plurality of optical sensors having different photosensitivity is known in general.

In the conventional solid-state image pickup device, photoreceptors having high photosensitivity and photoreceptors having low photosensitivity are arranged in the form of a honeycomb so as to be adjacent to each other on one-to-one ratio. In this conventional solid-state image pickup device, images taken with the photoreceptors having high photosensitivity and the photoreceptor having low photosensitivity respectively are acquired and selectively switched to be displayed on a screen in response to an amount of incident light. More specifically, the images taken with the photoreceptors having high photosensitivity are displayed when the amount of incident light is small and the images taken with the photoreceptors having low photosensitivity are displayed when the amount of incident light is large and saturated in the photoreceptors having high photosensitivity.

### SUMMARY OF THE INVENTION

A solid-state image pickup device according to an aspect of the present invention includes a plurality of optical sensors having different photosensitivity, wherein signals of the optical sensors having prescribed photosensitivity are read in response to object information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a structure of a solid-state image pickup device according to a first embodiment of the present invention;

FIG. 2 is a diagram showing arrangement of optical sensors having different photosensitivity arranged on a solid-state image sensor according to the first embodiment of the present invention;

FIG. 3 is a diagram showing selection of reading the optical sensors having different photosensitivity according to the first embodiment of the present invention;

FIG. 4 is a diagram showing the optical sensors read in response to luminance according to the first embodiment of the present invention;

FIG. 5 is a schematic diagram of a structure of a solid-state image pickup device according to a second embodiment of the present invention;

FIG. 6 is a diagram showing selection of reading optical sensors having different photosensitivity according to the second embodiment of the present invention;

FIG. 7 is a diagram showing the optical sensors reading in response to object moving speed of an object according to the second embodiment of the present invention;

FIG. 8 is a schematic diagram of a structure of a solid-state image pickup device according to a third embodiment of the present invention;

FIG. 9 is a diagram showing optical sensors read in response to a frame rate according to the third embodiment of the present invention;

FIG. 10 is a diagram showing arrangement of optical sensors having electron multiplication functions and optical sensors having no electron multiplication functions arranged on a solid-state image pickup device according to a fourth embodiment of the present invention;

FIG. 11 is a diagram showing the optical sensors read in response to object information according to a fourth embodiment of the present invention;

FIG. 12 is a diagram showing arrangement of optical sensors having different surface areas arranged on a solid-state image sensor according to a fifth embodiment of the present invention;

FIG. 13 is a diagram showing the optical sensors read in response to object information according to the fifth embodiment of the present invention;

FIG. 14 is a diagram showing arrangement of optical sensors having output amplifiers linearly amplifying outputs and optical sensors having output amplifiers logarithmic-functionally amplifying outputs according to a sixth embodiment of the present invention;

FIG. 15 is a diagram showing optical sensors read in response to object information according to the sixth embodiment of the present invention;

FIG. 16 is a diagram showing the relation between the luminance and the output of the output amplifiers linearly amplifying outputs according to the sixth embodiment of the present invention;

FIG. 17 is a diagram showing the relation between the luminance and the output of the output amplifiers logarithmic-functionally amplifying outputs according to the sixth embodiment of the present invention;

FIG. 18 is a diagram showing arrangement of optical sensors comprising lenses having different sensitivity and optical sensors comprising no lenses arranged on a solid-state image pickup device according to a seventh embodiment of the present invention;

FIG. 19 is a diagram showing the optical sensors read in response to object information according to the seventh embodiment of the present invention;

FIG. 20 is a diagram showing distribution of luminance in one frame on a solid-state image pickup device according to an eighth embodiment of the present invention;

FIG. 21 is a diagram showing selection of reading the optical sensors having different photosensitivity according to the eighth embodiment of the present invention; and

FIG. 22 is a diagram showing arrangement of optical sensors according to a modification of the first to eight embodiments of the present invention.

### DESCRIPTION OF THE PREFERRED EMBODIMENTS

Embodiments of the present invention will be hereinafter described with reference to the drawings.

### First Embodiment

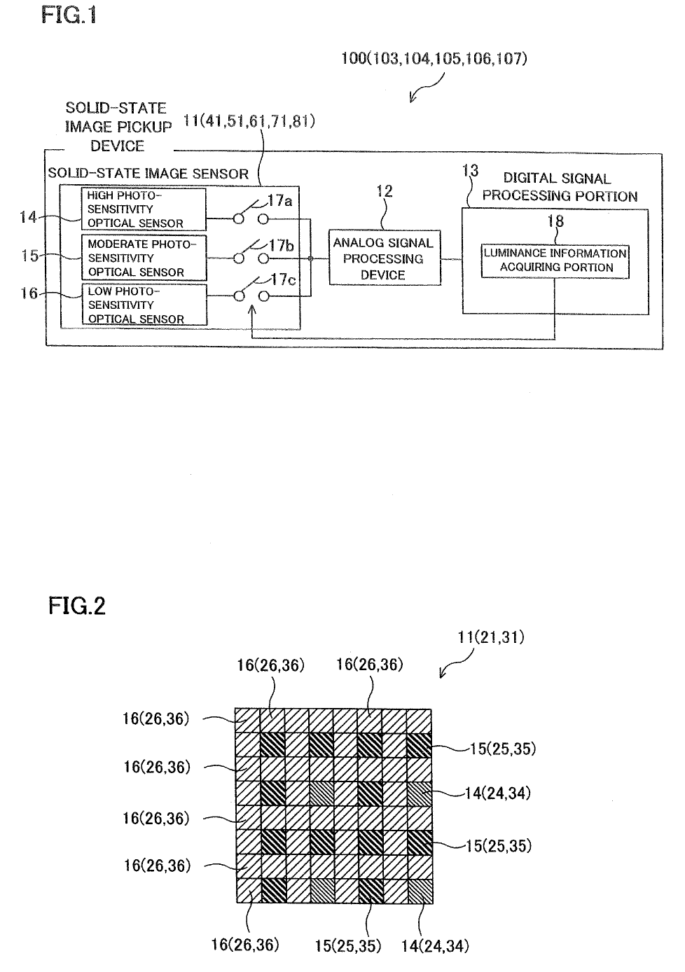

A structure of a solid-state image pickup device 100 according to a first embodiment will be described with reference to FIGS. 1 and 2.

This solid-state image pickup device 100 according to the first embodiment comprises a solid-state image sensor 11, an analog signal processing portion 12 and a digital signal processing portion 13, as shown in FIG. 1. The solid-state image sensor 11 includes high photosensitivity optical sensors 14, moderate photosensitivity optical sensors 15 and low photosensitivity optical sensors 16. The high photosensitivity optical sensors 14 are examples of the “sixth optical sensors” in the present invention. The moderate photosensitivity optical sensors 15 are examples of the “fifth optical sensors” in the present invention. The low photosensitivity optical sensors 16 are examples of the “fourth optical sensors” in the present invention. The high photosensitivity optical sensors 14, the moderate photosensitivity optical sensors 15 and the low photosensitivity optical sensors 16 are electrically connected to an analog signal processing device 12 through switches 17a, 17b and 17c respectively. The analog signal processing device 12 is electrically connected to the digital signal processing portion 13. The digital signal processing portion 13 includes a luminance information acquiring portion 18.

As shown in FIG. 2, the high photosensitivity optical sensors 14, the moderate photosensitivity optical sensors 15 and the low photosensitivity optical sensors 16, which are arranged on the solid-state image sensor 11 in the form of a matrix, are mixed.

An operation of the solid-state image pickup device 100 according to the first embodiment of the present invention will be now described with reference to FIGS. 1, 3 and 4.

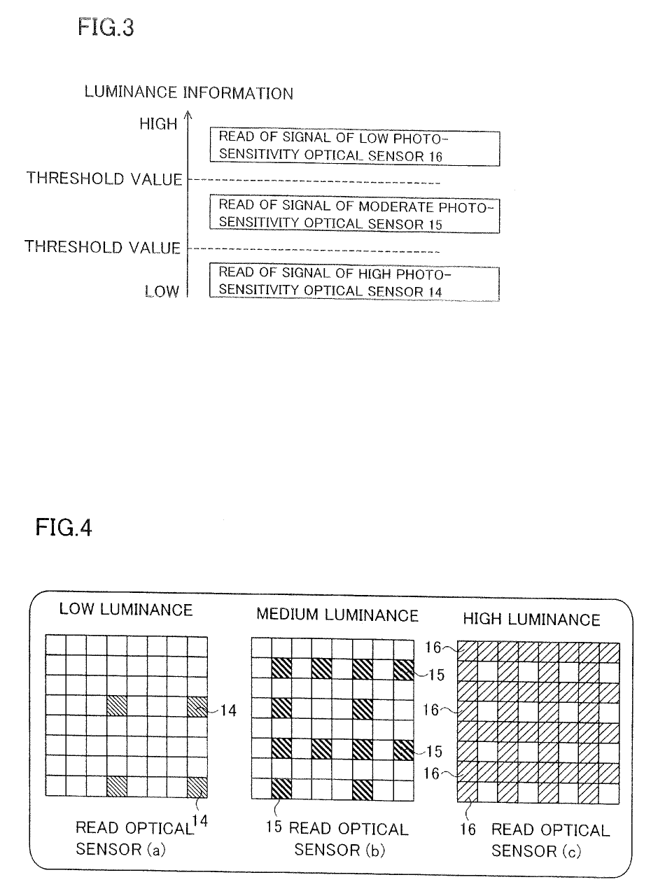

As shown in FIG. 1, the luminance information acquiring portion 18 in the digital signal processing portion 13 acquires luminance information of an object by calculating an average value of signals acquired when taking images on one frame (screen) prior to a frame of images to be now taken and inputted in the optical sensors of the one frame. According to the first embodiment, the high photosensitivity optical sensors 14 are read when the luminance is low (see the read optical sensors (a) in FIG. 4), the moderate photosensitivity optical sensors 15 are read when the luminance is moderate (see the read optical sensors (b) in FIG. 4), and the low photosensitivity optical sensors 16 are read when the luminance is high (see the read optical sensors (c) in FIG. 4), in response to the acquired luminance information on the basis of threshold values shown in FIG. 3. The threshold values of the read optical sensors shown in FIG. 3 are set by a user of the solid-state image pickup device 100.

According to the first embodiment, as hereinabove described, the solid-state image pickup device 100 is formed such that the signals inputted in one type of the optical sensors among three types of the high photosensitivity optical sensors 14, the moderate photosensitivity optical sensors 15 and the low photosensitivity optical sensors 16 are read in response to the luminance information of the object, whereby the signals of the optical sensors having unnecessary photosensitivity are not read. Thus, increase in processing time required for acquiring images can be suppressed and increase in power consumption of the solid-state image pickup device 100 can be suppressed.

According to the first embodiment, as hereinabove described, the object information is acquired on the basis of the luminance of the object, whereby the signals of the optical sensors having optimum photosensitivity among the high photosensitivity optical sensors 14, the moderate photosensitivity optical sensors 15 and the low photosensitivity optical sensors 16 can be read on the basis of the luminance of the object in taking images and hence images having optimum luminance in response to the object information can be obtained.

### Second Embodiment

In a second embodiment, a structure of a solid-state image pickup device 101 employing an object moving speed of an object as object information will be described with reference to FIGS. 2 and 5, dissimilarly to the aforementioned first embodiment.

This solid-state image pickup device 101 according to the second embodiment comprises a solid-state image sensor 21, an analog signal processing portion 22 and a digital signal processing portion 23, as shown in FIG. 5. The solid-state image sensor 21 includes high photosensitivity optical sensors 24, moderate photosensitivity optical sensors 25 and low photosensitivity optical sensors 26. The high photosensitivity optical sensors 24 are examples of the “sixth optical sensors” in the present invention. The moderate photosensitivity optical sensors 25 are examples of the “fifth optical sensors” in the present invention. The low photosensitivity optical sensors 26 are examples of the “fourth optical sensors” in the present invention. The high photosensitivity optical sensors 24, the moderate photosensitivity optical sensors 25 and the low photosensitivity optical sensors 26 are electrically connected to an analog signal processing device 22 through switches 27a, 27b and 27c respectively. The analog signal processing device 22 is electrically connected to the digital signal processing portion 23. The digital signal processing portion 23 includes an object moving speed-information acquiring portion 28.

As shown in FIG. 2, the high photosensitivity optical sensors 24, the moderate photosensitivity optical sensors 25 and the low photosensitivity optical sensors 26, which are arranged on the solid-state image sensor 21 in the form of a matrix, are mixed, similarly to the first embodiment. According to the second embodiment, the number of the arranged high photosensitivity optical sensors 24 is larger than that of the arranged low photosensitivity optical sensors 26, and the number of the arranged moderate photosensitivity optical sensors 25 is in the range between the number of the arranged high photosensitivity optical sensors 24 and the number of the arranged low photosensitivity optical sensors 26

An operation of the solid-state image pickup device 101 according to the second embodiment of the present invention will be now described with reference to FIGS. 5 to 7.

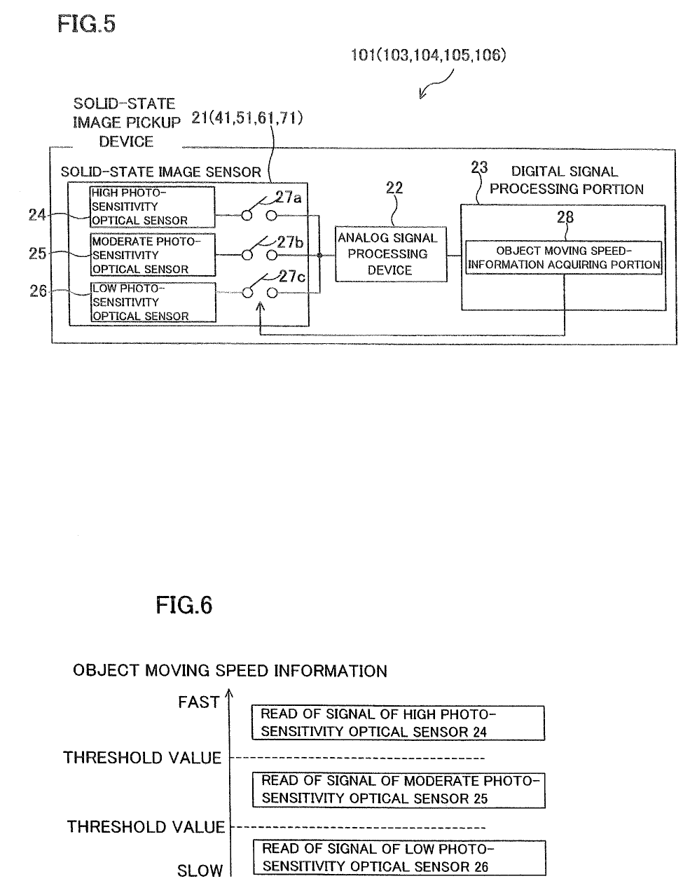

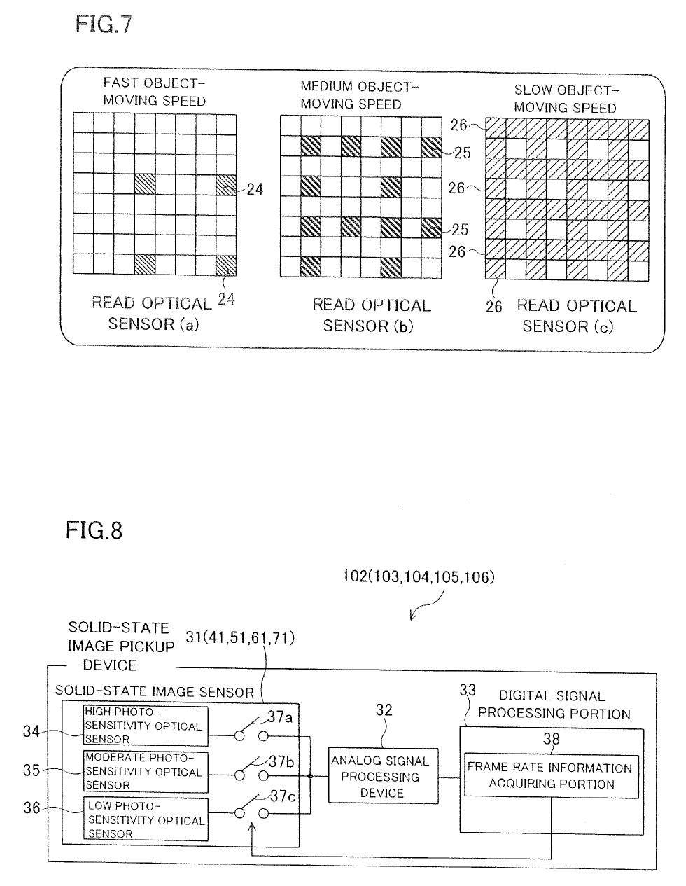

As shown in FIG. 5, the object moving speed-information acquiring portion 28 in the digital signal processing portion 23 acquires object moving speed information of an object on the basis of signals acquired when taking images on a plurality of frames (screens) prior to a frame of images to be now taken and inputted in the optical sensors. According to the second embodiment, the signals inputted in one type of the optical sensors among three types of the high photosensitivity optical sensors 24, the moderate photosensitivity optical sensors 25 and the low photosensitivity optical sensors 26 are read in response to the object moving speed information acquired on the basis of threshold values shown in FIG. 6. The threshold values of the read optical sensors shown in FIG. 6 are set by a user of the solid-state image pickup device 101. The high photosensitivity optical sensors 24 are read when the object moving speed is fast (see the read optical sensors (a) in FIG. 7). The high photosensitivity optical sensors 24 have higher photosensitivity than that of the low photosensitivity optical sensors 26 and hence exposure time can be reduced as compared with the low photosensitivity optical sensors 26. Thus, it is possible to take images of an object whose object moving speed is fast. The moderate photosensitivity optical sensors 25 are read when the object moving speed is moderate (see the read optical sensors (b) in FIG. 7) and it is possible to take images of an object moving at a moderate speed. The number of the moderate photosensitivity optical sensors 25 is larger than the number of the high photosensitivity optical sensors 24 and hence it is possible to obtain images having higher resolution than those obtained by the high photosensitivity optical sensors 24. The low photosensitivity optical sensors 26 are read when the object moving speed is slow (see the read optical sensors (c) in FIG. 7). The number of the low photosensitivity optical sensors 26 is larger than the number of the high photosensitivity optical sensors 24 or the moderate photosensitivity optical sensors 25 and hence it is possible to obtain images having higher resolution than those obtained by the high photosensitivity optical sensors 24 or the moderate photosensitivity optical sensors 25.

According to the second embodiment, as hereinabove described, the solid-state image pickup device 101 is formed such that the signals inputted in one type of the optical sensors among three types of the high photosensitivity optical sensors 24, the moderate photosensitivity optical sensors 25 and the low photosensitivity optical sensors 26 are read in response to the object moving speed information of the object, whereby the signals of the optical sensors having unnecessary photosensitivity are not read. Thus, increase in processing time required for acquiring images can be suppressed and increase in power consumption of the solid-state image pickup device 101 can be suppressed.

According to the second embodiment, as hereinabove described, the object information is acquired on the basis of the object moving speed, whereby the signals of the optical sensors having optimum photosensitivity among the high photosensitivity optical sensors 24, the moderate photosensitivity optical sensors 25 and the low photosensitivity optical sensors 26 can be read on the basis of the object moving speed of the object in taking images and hence images having optimum object moving speed in response to the object information can be obtained.

According to the second embodiment, as hereinabove described, the respective numbers of the high photosensitivity optical sensors 24, the moderate photosensitivity optical sensors 25 and the low photosensitivity optical sensors 26 are different, whereby signals of the optical sensors having optimum resolution among the high photosensitivity optical sensors 24, the moderate photosensitivity optical sensors 25 and the low photosensitivity optical sensors 26 can be read and hence images having the optimum resolution and object moving speed in response to the object information can be obtained.

### Third Embodiment

In a third embodiment, a structure of a solid-state image pickup device 102 employing the number of screens renewed per unit time suitable for taking images of an object (hereinafter referred to as frame rate information) as object information will be described with reference to FIGS. 2 and 8, dissimilarly to the aforementioned first embodiment.

This solid-state image pickup device according to the third embodiment comprises a solid-state image sensor 31, an analog signal processing portion 32 and a digital signal processing portion 33, as shown in FIG. 8. The solid-state image sensor 31 includes high photosensitivity optical sensors 34, moderate photosensitivity optical sensors 35 and low photosensitivity optical sensors 36. The high photosensitivity optical sensors 34 are examples of the “sixth optical sensors” in the present invention. The moderate photosensitivity optical sensors 35 are examples of the “fifth optical sensors” in the present invention. The low photosensitivity optical sensors 36 are examples of the “fourth optical sensors” in the present invention. The high photosensitivity optical sensors 34, the moderate photosensitivity optical sensors 35 and the low photosensitivity optical sensors 36 are electrically connected to an analog signal processing device 32 through switches 37a, 37b and 37c respectively. The analog signal processing device 32 is electrically connected to the digital signal processing portion 33. The digital signal processing portion 33 includes a frame rate information acquiring portion 38.

As shown in FIG. 2, the high photosensitivity optical sensors 34, the moderate photosensitivity optical sensors 35 and the low photosensitivity optical sensors 36, which are arranged on the solid-state image sensor 31 in the form of a matrix, are mixed similarly to the first embodiment. According to third embodiment, the number of the arranged low photosensitivity optical sensors 36 is larger than that of the arranged high photosensitivity optical sensors 34, and the number of the arranged moderate photosensitivity optical sensors 35 is in the range between the number of the arranged high photosensitivity optical sensors 34 and the number of the arranged low photosensitivity optical sensors 36 similarly to the second embodiment.

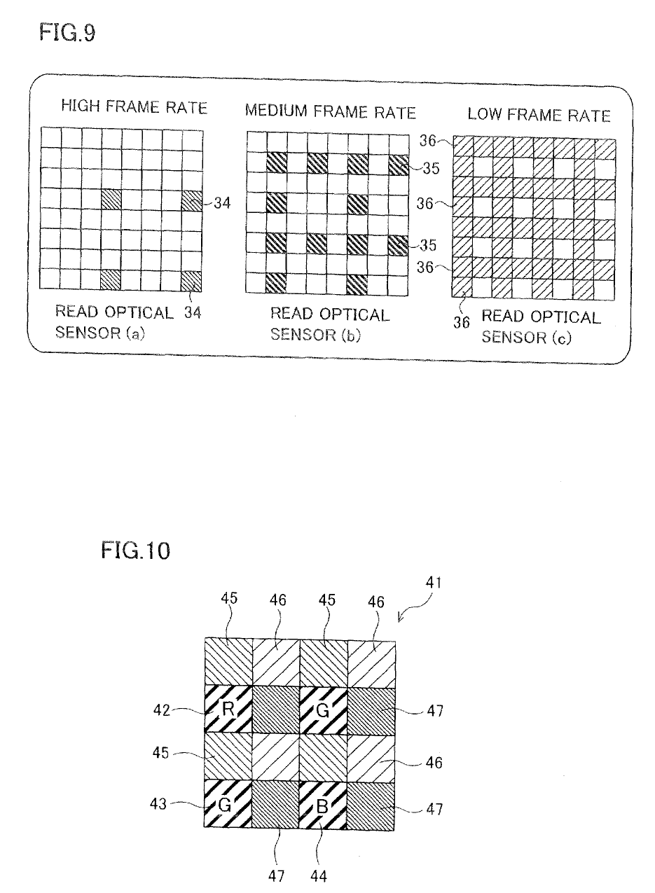

An operation of the solid-state image pickup device 102 according to the third embodiment of the present invention will be now described with reference to FIGS. 8 and 9.

As shown in FIG. 8, the frame rate information acquiring portion 38 in the digital signal processing portion 33 acquires frame rate information suitable for taking images of an object. According to the third embodiment, the signals inputted in one type of the optical sensors among three types of the high photosensitivity optical sensors 34, the moderate photosensitivity optical sensors 35 and the low photosensitivity optical sensors 36 are read on the basis of the frame rate information. The high photosensitivity optical sensors 34, the number of which is small, are read when high frame rate is required for taking images of the object (see the read optical sensors (a) in FIG. 9). The high photosensitivity optical sensors 34 have higher photosensitivity than that of the low photosensitivity optical sensors 36 and hence exposure time can be reduced as compared with the low photosensitivity optical sensors 36 and the read time can be reduced since the number of the arranged optical sensors is small. Thus, the high photosensitivity optical sensors 34 can obtain images with the high frame rate. The moderate photosensitivity optical sensors 35 are read when medium frame rate is required for taking images of the object (see the read optical sensors (b) in FIG. 9) and the number of the moderate photosensitivity optical sensors 35 is larger than that of the high photosensitivity optical sensors 34, and hence it is possible to take images with the medium frame rate and to obtain images having higher resolution than that of the images obtained by the high photosensitivity optical sensors 34. The low photosensitivity optical sensors 36 are read when low frame rate is required for taking images of the object (see the read optical sensors (c) in FIG. 9). The number of the low photosensitivity optical sensors 36 is larger than the number of the high photosensitivity optical sensors 34 or the moderate photosensitivity optical sensors 35, and hence it is possible to obtain images having higher resolution than that of the images obtained by the high photosensitivity optical sensors 34 or the moderate photosensitivity optical sensors 35.

According to the third embodiment, as hereinabove described, the solid-state image pickup device 102 is formed such that the signals inputted in one type of the optical sensors among three types of the high photosensitivity optical sensors 34, the moderate photosensitivity optical sensors 35 and the low photosensitivity optical sensors 36 are read in response to the frame rate information suitable for taking images of the object, whereby the signals of the optical sensors having unnecessary photosensitivity are not read. Thus, increase in processing time required for acquiring images can be suppressed and increase in power consumption of the solid-state image pickup device 102 can be suppressed.

According to the third embodiment, as hereinabove described, the object information is acquired on the basis of the frame rate information suitable for taking images of the object, whereby the signals of the optical sensors with optimum frame rate among the high photosensitivity optical sensors 34, the moderate photosensitivity optical sensors 35 and the low photosensitivity optical sensors 36 can be read on the basis of the frame rate information suitable for taking images of the object and hence images with the optimum frame rate in response to the object information can be obtained.

When an object of a camera (security camera, portrait, etc.) is previously known, the object information can be fixed. For example, when the object is to measure a moving object, photographing with high frame rate is performed. When the object is monitoring, photographing with medium frame rate and medium resolution is performed. When a portrait is taken, photographing with high resolution is performed.

### Fourth Embodiment

In a fourth embodiment, a structure of a solid-state image pickup device 103 including optical sensors having electron multiplication functions will be described with reference to FIGS. 1, 5, 8 and 10, dissimilarly to the aforementioned first to third embodiments.

In the structure of the solid-state image pickup device 103 according to the fourth embodiment, the high photosensitivity optical sensors 14, 24 and 34, the moderate photosensitivity optical sensors 15, 25 and 35 and the low photosensitivity optical sensors 16, 26 and 36 included in the solid-state image sensors 11, 21 and 31 of the solid-state image pickup devices according to the first, second and third embodiments shown in FIGS. 1, 5 and 8 are replaced with an optical sensor 42 comprising a red color filter having the electron multiplication function, optical sensors 43 comprising green color filters having the electron multiplication functions, an optical sensor 44 comprising a blue color filter having the electron multiplication function, optical sensors 45 comprising red color filters having no electron multiplication functions, optical sensors 46 comprising green color filters having no electron multiplication functions and optical sensors 47 comprising blue color filters having no electron multiplication functions described later.

As shown in FIG. 10, the optical sensor 42 comprising the red color filter having the electron multiplication function, the optical sensors 43 comprising the green color filters having the electron multiplication functions, the optical sensor 44 comprising the blue color filter having the electron multiplication function, the optical sensors 45 comprising the red color filters having no electron multiplication functions, the optical sensors 46 comprising the green color filters having no electron multiplication functions and the optical sensors 47 comprising the blue color filters having no electron multiplication functions, which are arranged on the solid-state image sensor 41 in the form of a matrix, are mixed. The optical sensor 42 comprising the red color filter having the electron multiplication function, the optical sensors 43 comprising the green color filters having the electron multiplication functions, the optical sensor 44 comprising the blue color filter having the electron multiplication function, the optical sensors 45 comprising the red color filters having no electron multiplication functions, the optical sensors 46 comprising the green color filters having no electron multiplication functions and the optical sensors 47 comprising the blue color filters having no electron multiplication functions are examples of the “optical sensors” in the present invention. According to the fourth embodiment, the number of the arranged optical sensors 42, 43 and 44 having the electron multiplication functions is larger than the number of the arranged optical sensors 45, 46 and 47 having no electron multiplication functions.

An operation of the solid-state image pickup device 103 according to the fourth embodiment of the present invention will be now described with reference to FIGS. 1, 5, 8 and 11.

When the optical sensors to be read are different in response to luminance information of an object, a luminance information acquiring portion 18 in a digital signal processing portion 13 acquires luminance information of the object by calculating an average value of signals acquired when taking images on one frame (screen) prior to a frame of images to be now taken and inputted in the optical sensors of the one frame, as shown in FIG. 1. According to the fourth embodiment, the optical sensors 42, 43 and 44 having the electron multiplication functions are read on the basis of a threshold value set by a user of the solid-state image pickup device 103 when the luminance is low (see the read optical sensors (a) in FIG. 11). When the luminance is high, the optical sensors 42, 43 and 44 having the electron multiplication functions which are turned off (optical sensors having the same photosensitivity as that of the optical sensors 45, 46 and 47 having no electron multiplication functions) and the optical sensors 45, 46 and 47 having no electron multiplication functions are read (see the read optical sensors (b) in FIG. 11).

When the optical sensors to be read are different in response to object moving speed information of the object, an object moving speed-information acquiring portion 28 in a digital signal processing portion 23 acquires object moving speed information of the object on the basis of signals acquired when taking images on a plurality of frames (screens) prior to a frame of images to be now taken and inputted in the optical sensors, as shown in FIG. 5. The optical sensors 42, 43 and 44 having the electron multiplication functions are read on the basis of a threshold value set by the user of the solid-state image pickup device 103 when the object moving speed is fast (see the read optical sensors (a) in FIG. 11). When the object moving speed is slow, the optical sensors 42, 43 and 44 having the electron multiplication functions which are turned off (optical sensors having the same photosensitivity as that of the optical sensors 45, 46 and 47 having no electron multiplication functions) and the optical sensors 45, 46 and 47 having no electron multiplication functions are read (see the read optical sensors (b) in FIG. 11). The optical sensors 42, 43 and 44 having the electron multiplication functions have higher photosensitivity than that of the optical sensors 45, 46 and 47 having no electron multiplication functions and hence exposure time can be reduced as compared with the optical sensors 45, 46 and 47 having no electron multiplication functions.

When the optical sensors to be read are different in response to frame rate information, a frame rate information acquiring portion 38 in a digital signal processing portion 33 acquires frame rate information suitable for taking images of the object, as shown in FIG. 8. When high frame rate is required for taking images of the object, the optical sensors 42, 43 and 44 having the electron multiplication functions are read (see the read optical sensors (a) in FIG. 11). When low frame rate is required for taking images of the object, the optical sensors 42, 43 and 44 having the electron multiplication functions which are turned off (optical sensors having the same photosensitivity as that of the optical sensors 45, 46 and 47 having no electron multiplication functions) and the optical sensors 45, 46 and 47 having no electron multiplication functions are read (see the read optical sensors (b) in FIG. 11).

According to the fourth embodiment, as hereinabove described, the solid-state image pickup device 103 comprises the optical sensors 42, 43 and 44 having the electron multiplication functions and the optical sensors 45, 46 and 47 having no electron multiplication functions, whereby the solid-state image pickup device 103 can be formed such that signals of the high photosensitivity optical sensors 42, 43 and 44 having the electron multiplication functions are read when the luminance of the object is low while both signals of the optical sensors 42, 43 and 44 having the electron multiplication functions which are turned off and the optical sensors 45, 46 and 47 having no electron multiplication functions are read when the luminance of the object is high. Thus, images having high photosensitivity can be obtained when the luminance of the object is low and images having high resolution can be obtained when the luminance of the object is high.

According to the fourth embodiment, as hereinabove described, the solid-state image pickup device 103 comprises the optical sensors 42, 43 and 44 having the electron multiplication functions and the optical sensors 45, 46 and 47 having no electron multiplication functions, whereby the solid-state image pickup device 103 can be formed such that the signals of the optical sensors 42, 43 and 44 having the electron multiplication functions are read when the object moving speed is fast while both signals of the optical sensors 42, 43 and 44 having the electron multiplication functions which are turned off and the optical sensors 45, 46 and 47 having no electron multiplication functions are read when the object moving speed is slow. Thus, exposure time of the optical sensors 42, 43 and 44 having the electron multiplication functions can be reduced when the object moving speed is slow, and hence images of the object moving at high speed can be taken. When the object moving speed is slow, images having high resolution can be obtained.

According to the fourth embodiment, as hereinabove described, the solid-state image pickup device 103 comprises the optical sensors 42, 43 and 44 having the electron multiplication functions and the optical sensors 45, 46 and 47 having no electron multiplication functions, whereby the solid-state image pickup device 103 can be formed such that the signals of the optical sensors 42, 43 and 44 having the electron multiplication functions are read when the high frame rate is required while both signals of the optical sensors 42, 43 and 44 having the electron multiplication functions which are turned off and the optical sensors 45, 46 and 47 having no electron multiplication functions are read when the low frame rate is required. Thus, exposure time of the optical sensors 42, 43 and 44 having the electron multiplication functions can be reduced and read time can be reduced since the number of the arranged optical sensors is small, and hence images with the high frame rate can be obtained when the high frame rate is required. When the low frame rate is required, images having high resolution can be obtained.

### Fifth Embodiment

In a fifth embodiment, a structure of a solid-state image pickup device 104 including optical sensors having different sizes will be described with reference to FIGS. 1, 5, 8 and 12, dissimilarly to the aforementioned fourth embodiment.

In the structure of the solid-state image pickup device 104 according to the fifth embodiment, the high photosensitivity optical sensors 14, 24 and 34, the moderate photosensitivity optical sensors 15, 25 and 35 and the low photosensitivity optical sensors 16, 26 and 36 included in the solid-state image sensors 11, 21 and 31 of the solid-state image pickup devices according to the first, second and third embodiments shown in FIGS. 1, 5 and 8 are replaced with an optical sensor 52 with a large surface area comprising any of red, green and blue color filters, optical sensors 53 with medium surface areas comprising any of the red, green and blue color filters, optical sensors 54 with small surface areas comprising red color filters, optical sensors 55 with small surface areas comprising green color filters and optical sensors 56 with small surface areas comprising blue color filters described later.

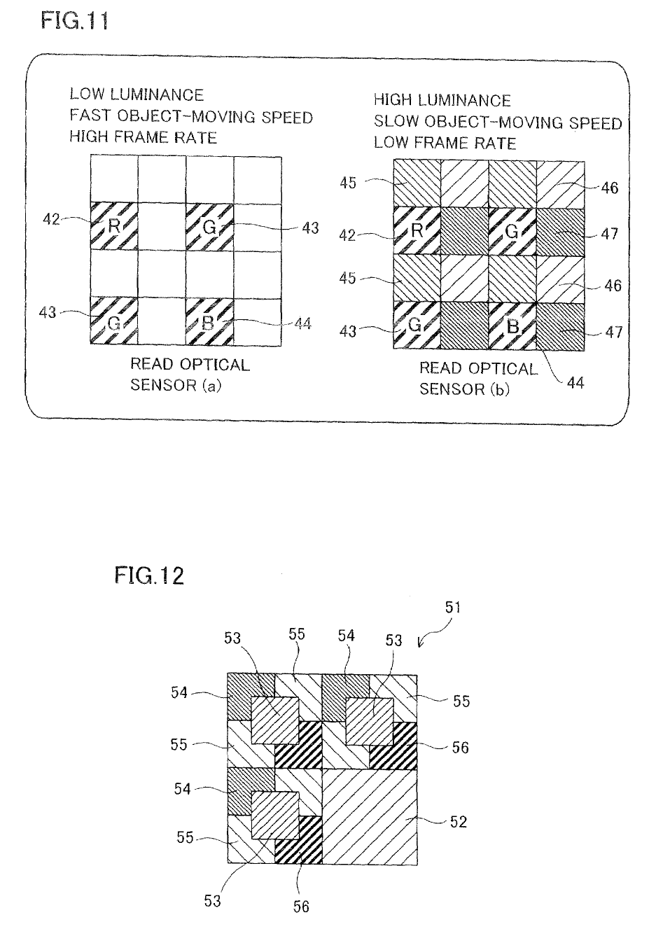

As shown in FIG. 12, the optical sensor 52 with the large surface area comprising any of the red, green and blue color filters, the optical sensors 53 with the medium surface areas comprising any of the red, green and blue color filters, the optical sensors 54 with the small surface areas comprising the red color filters, the optical sensors 55 with the small surface areas comprising the green color filters and the optical sensors 56 with the small surface areas comprising the blue color filters, which are arranged on the solid-state image sensor 51 in the form of a matrix, are mixed. The optical sensor 52 with the large surface area and the optical sensors 53 with the medium surface areas are examples of the “third optical sensors” and the “second optical sensors” in the present invention respectively. The optical sensors 54, 55 and 56 with the small surface areas are examples of the “first optical sensors” in the present invention. According to the fifth embodiment, the number of the arranged optical sensor 52 with the large surface area is larger than the number of the arranged optical sensors 54, 55 and 56 with the small surface areas and the number of the arranged optical sensors 53 with the medium surface areas is in the range between the number of the arranged optical sensor 52 with the large surface area and the number of the arranged optical sensors 54, 55 and 56 with the small surface areas.

An operation of the solid-state image pickup device 104 according to the fifth embodiment of the present invention will be now described with reference to FIGS. 1, 5, 8 and 13.

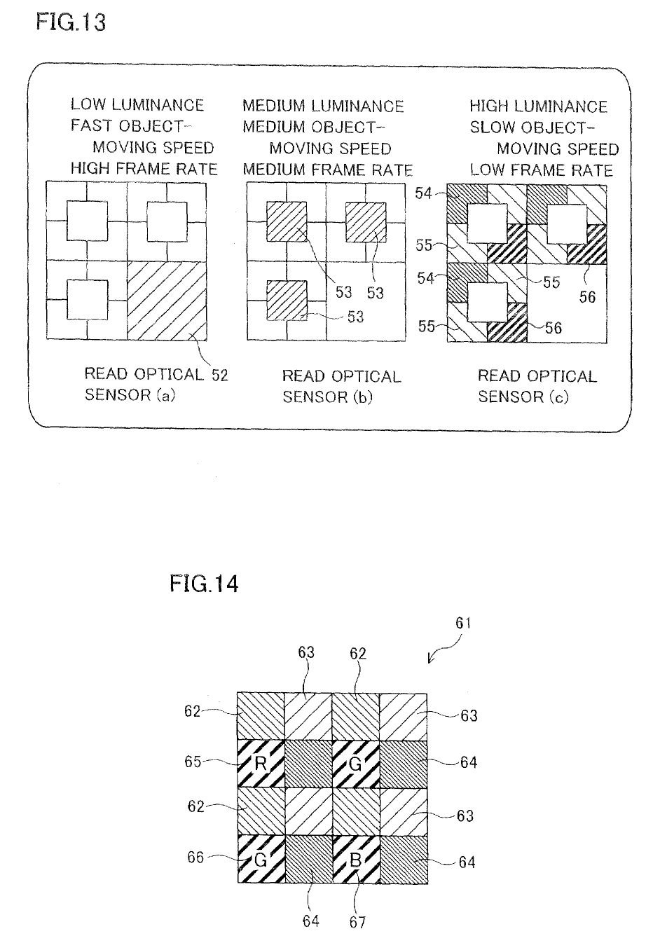

When the optical sensors to be read are different in response to luminance information of an object, a luminance information acquiring portion 18 in a digital signal processing portion 13 acquires luminance information of the object by calculating an average value of signals acquired when taking images on one frame (screen) prior to a frame of images to be now taken and inputted in the optical sensors of the one frame, as shown in FIG. 1. According to the fifth embodiment, the optical sensor 52 with the large surface area are read on the basis of a threshold value set by a user of the solid-state image pickup device 104 when the luminance is low (see the read optical sensors (a) in FIG. 13). When the luminance is moderate, the optical sensors 53 with the medium surface areas are read (see the read optical sensors (b) in FIG. 13). When the luminance is high, the optical sensors 54, 55 and 56 with the small surface areas are read (see the read optical sensors (c) in FIG. 13).

When the optical sensors to be read are different in response to object moving speed information of the object, an object moving speed-information acquiring portion 28 in a digital signal processing portion 23 acquires object moving speed information of the object on the basis of signals acquired when taking images on a plurality of frames (screens) prior to a frame of images to be now taken and inputted in the optical sensors, as shown in FIG. 5. The optical sensor 52 with the large surface area are read on the basis of a threshold value set by the user of the solid-state image pickup device 104 when the object moving speed is fast (see the read optical sensors (a) in FIG. 13). When the object moving speed is moderate, the optical sensors 53 with the medium surface areas are read (see the read optical sensors (b) in FIG. 13). When the object moving speed is slow, the optical sensors 54, 55 and 56 with the small surface areas are read (see the read optical sensors (c) in FIG. 13). The optical sensor 52 with the large surface area have higher photosensitivity than that of the optical sensors 54, 55 and 56 with the small surface areas and hence exposure time can be reduced as compared with the optical sensors 54, 55 and 56 with the small surface areas. The exposure time of the optical sensors 53 with the medium surface areas is in the range between the exposure time of the optical sensor 52 with the large surface area and the exposure time of the optical sensors 54, 55 and 56 with the small surface areas.

When the optical sensors to be read are different in response to frame rate information, a frame rate information acquiring portion 38 in a digital signal processing portion 33 acquires frame rate information suitable for taking images of the object, as shown in FIG. 8. When high frame rate is required for taking images of the object, the optical sensor 52 with the large surface area are read (see the read optical sensors (a) in FIG. 13). When medium frame rate is required for taking images of the object, the optical sensors 53 with the medium surface areas are read (see the read optical sensors (b) in FIG. 13). When low frame rate is required for taking images of the object, the optical sensors 54, 55 and 56 with the small surface areas are read (see the read optical sensors (c) in FIG. 13).

According to the fifth embodiment, as hereinabove described, the solid-state image pickup device 104 comprises the optical sensor 52 with the large surface area, the optical sensors 53 with the medium surface areas and the optical sensors 54, 55 and 56 with the small surface areas, whereby the solid-state image pickup device 104 can be formed such that signal of the optical sensor 52 with the large surface area is read when the luminance of the object is low, signals of the optical sensors 53 with the medium surface areas are read when the luminance of the object is moderate, and signals of the optical sensors 54, 55 and 56 with the small surface areas are read when the luminance of the object is high. Thus, images having high photosensitivity can be obtained when the luminance of the object is low. Images having moderate photosensitivity and resolution can be obtained when the luminance of the object is moderate. The number of the optical sensors 54, 55 and 56 with the small surface areas is larger than the number of the optical sensor 52 with the large surface area and the number of the optical sensors 53 with the medium surface areas, whereby images having high resolution can be obtained when the luminance of the object is high.

According to the fifth embodiment, as hereinabove described, the solid-state image pickup device 104 comprises the optical sensor 52 with the large surface area, the optical sensors 53 with the medium surface areas and the optical sensors 54, 55 and 56 with the small surface areas, whereby the solid-state image pickup device 104 can be formed such that the signal of the optical sensor 52 with the large surface area is read when the object moving speed is fast, the signals of the optical sensors 53 with the medium surface areas are read when the object moving speed is moderate, and the signals of the optical sensors 54, 55 and 56 with the small surface areas are read when the object moving speed is slow. Thus, exposure time of the optical sensor 52 with the large surface area is reduced when the object moving speed is fast, and hence images of the object moving at high speed can be taken. When the object moving speed is moderate, images of the object moving at medium object moving speed can be taken and images having medium resolution can be obtained. The number of the optical sensors 54, 55 and 56 with the small surface areas is larger than the number of the optical sensor 52 with the large surface area and the number of the optical sensors 53 with the medium surface areas, whereby images having high resolution can be obtained when the object moving speed is slow.

According to the fifth embodiment, as hereinabove described, the solid-state image pickup device 104 comprises the optical sensor 52 with the large surface area, the optical sensors 53 with the medium surface areas and the optical sensors 54, 55 and 56 with the small surface areas, whereby the solid-state image pickup device 104 can be formed such that the signal of the optical sensor 52 with the large surface area is read when the high frame rate is required, the signals of the optical sensors 53 with the medium surface areas are read when the medium frame rate is required, and the signals of the optical sensors 54, 55 and 56 with the small surface areas are read when the low frame rate is required. Thus, exposure time of the optical sensor 52 with the large surface area can be reduced and read time can be reduced since the number of the arranged optical sensors is small, whereby images with the high frame rate can be obtained when the high frame rate is required. When the object moving speed is moderate, images with the medium frame rate can be taken and images having medium resolution can be obtained. The number of the optical sensors 54, 55 and 56 with the small surface areas is larger than the number of the optical sensor 52 with the large surface area and the number of the optical sensors 53 with the medium surface areas, whereby images having high resolution can be obtained when the low frame rate is required.

### Sixth Embodiment

In a sixth embodiment, a structure of a solid-state image pickup device 105 including optical sensors 62, 63 and 64 having output amplifiers linearly amplifying outputs and optical sensors 65, 66 and 67 having output amplifiers logarithmic-functionally amplifying outputs will be described with reference to FIGS. 1, 5, 8 and 14, dissimilarly to the aforementioned first to fifth embodiments.

In the structure of the solid-state image pickup device 105 according to the sixth embodiment, the high photosensitivity optical sensors 14, 24 and 34, the moderate photosensitivity optical sensors 15, 25 and 35 and the low photosensitivity optical sensors 16, 26 and 36 included in the solid-state image sensors 11, 21 and 31 of the solid-state image pickup devices according to the first, second and third embodiments shown in FIGS. 1, 5 and 8 are replaced with optical sensors 62 comprising red color filters having the output amplifiers linearly amplifying the outputs, optical sensors 63 comprising green color filters having the output amplifiers linearly amplifying the outputs, optical sensors 64 comprising blue color filters having the output amplifiers linearly amplifying the outputs, an optical sensor 65 comprising a red color filter having the output amplifier logarithmic-functionally amplifying the output, optical sensors 66 comprising green color filters having the output amplifiers logarithmic-functionally amplifying the outputs and an optical sensor 67 comprising a blue color filter having the output amplifier logarithmic-functionally amplifying the output described later.

As shown in FIG. 14, the optical sensors 62 comprising the red color filters having the output amplifiers linearly amplifying the outputs, the optical sensors 63 comprising the green color filters having the output amplifiers linearly amplifying the outputs, the optical sensors 64 comprising the blue color filters having the output amplifiers linearly amplifying the outputs, the optical sensor 65 comprising the red color filter having the output amplifier logarithmic functionally amplifying the output, the optical sensors 66 comprising the green color filters having the output amplifiers logarithmic-functionally amplifying the outputs and the optical sensor 67 comprising the blue color filter having the output amplifier logarithmic-functionally amplifying the output, which are arranged on the solid-state image sensor 61 in the form of a matrix, are mixed. The optical sensors 62 comprising the red color filters having the output amplifiers linearly amplifying the outputs, the optical sensors 63 comprising the green color filters having the output amplifiers linearly amplifying the outputs, the optical sensors 64 comprising the blue color filters having the output amplifiers linearly amplifying the outputs, the optical sensor 65 comprising the red color filter having the output amplifier logarithmic-functionally amplifying the output, the optical sensors 66 comprising the green color filters having the output amplifiers logarithmic-functionally amplifying the outputs and the optical sensor 67 comprising the blue color filter having the output amplifier logarithmic-functionally amplifying the output are examples of the “optical sensors” in the present invention.

An operation of the solid-state image pickup device 105 according to the sixth embodiment of the present invention will be now described with reference to FIGS. 1, 5, 8, 15, 16 and 17.

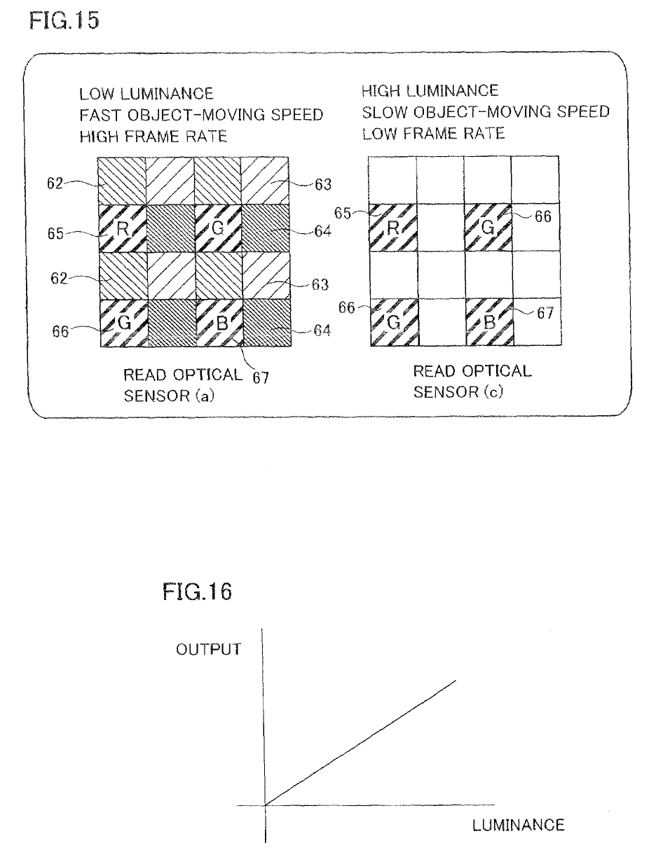

When the optical sensors to be read are different in response to luminance information of an object, a luminance information acquiring portion 18 in a digital signal processing portion 13 acquires luminance information of the object by calculating an average value of signals acquired when taking images on one frame (screen) prior to a frame of images to be now taken and inputted in the optical sensors of the one frame, as shown in FIG. 1. According to the sixth embodiment, both of the optical sensors 62, 63 and 64 having the output amplifiers linearly amplifying the outputs and the optical sensors 65, 66 and 67 having the output amplifiers logarithmic-functionally amplifying the outputs are read on the basis of a threshold value set by a user of the solid-state image pickup device 105 when the luminance is in the range of low and moderate levels (see the read optical sensors (a) in FIG. 15). As shown in FIG. 16, the optical sensors 62, 63 and 64 having the output amplifiers linearly amplifying the outputs are formed such that the outputs linearly increases as the luminance gets higher. As shown in FIG. 17, the optical sensors 65, 66 and 67 having the output amplifiers logarithmic-functionally amplifying the outputs are formed such that the outputs logarithmic-functionally increases as the luminance gets higher and the ratio of amplification of the outputs is reduced as the luminance gets higher. A conversion process is performed on the output of each output amplifier logarithmic-functionally amplifying the output through digital signal processing such that the output of each output amplifier logarithmic-functionally amplifying the output has the same signal level as that of each output amplifier linearly amplifying the output. When the luminance is high, the optical sensors 65, 66 and 67 having the output amplifiers logarithmic-functionally amplifying the outputs are read (see the read optical sensors (b) in FIG. 15).

When the optical sensors to be read are different in response to object moving speed information of the object, an object moving speed-information acquiring portion 28 in a digital signal processing portion 23 acquires object moving speed information of the object on the basis of signals acquired when taking images on a plurality of frames (screens) prior to a frame of images to be now taken and inputted in the optical sensors, as shown in FIG. 5. Both of the optical sensors 62, 63 and 64 having the output amplifiers linearly amplifying the outputs and the optical sensors 65, 66 and 67 having the output amplifiers logarithmic-functionally amplifying the outputs are read on the basis of a threshold value set by the user of the solid-state image pickup device 105 when the object moving speed is slow (see the read optical sensors (a) in FIG. 15). A conversion process is performed on the output of each output amplifier logarithmic-functionally amplifying the output through digital signal processing such that the output of each output amplifier logarithmic-functionally amplifying the output has the same signal level as that of each output amplifier linearly amplifying the output. When the object moving speed is fast, the optical sensors 65, 66 and 67 having the output amplifiers logarithmic-functionally amplifying the outputs are read (see the read optical sensors (b) in FIG. 15).

When the optical sensors to be read are different in response to frame rate information, a frame rate information acquiring portion 38 in a digital signal processing portion 33 acquires frame rate information suitable for taking images of the object, as shown in FIG. 8. When low frame rate is required for taking images of the object, both of the optical sensors 62, 63 and 64 having the output amplifiers linearly amplifying the outputs and the optical sensors 65, 66 and 67 having the output amplifiers logarithmic-functionally amplifying the outputs are read (see the read optical sensors (a) in FIG. 15). A conversion process is performed on the output of each output amplifier logarithmic-functionally amplifying the output through digital signal processing such that the output of each output amplifier logarithmic-functionally amplifying the output has the same signal level as that of each output amplifier linearly amplifying the output. When high frame rate is required for taking images of the object, the optical sensors 65, 66 and 67 having the output amplifiers logarithmic-functionally amplifying the outputs are read (see the read optical sensors (b) in FIG. 15).

According to the sixth embodiment, as hereinabove described, the solid-state image pickup device 105 comprises the optical sensors 62, 63 and 64 having the output amplifiers linearly amplifying the outputs and the optical sensors 65, 66 and 67 having the output amplifiers logarithmic-functionally amplifying the outputs, whereby the solid-state image pickup device 105 can be formed such that both signals of the optical sensors 62, 63 and 64 having the output amplifiers linearly amplifying the output and the optical sensors 65, 66 and 67 having the output amplifiers logarithmic-functionally amplifying the output are read when the luminance of the object is low while the optical sensors 65, 66 and 67 having the output amplifiers logarithmic-functionally amplifying the outputs when the luminance of the object is high. Thus, images having high resolution can be obtained when the luminance of the object is low, and a phenomenon of excessively amplifying the outputs with the output amplifiers due to high luminance can be suppressed when the luminance of the object is high.

According to the sixth embodiment, as hereinabove described, the solid-state image pickup device 105 comprises the optical sensors 62, 63 and 64 having the output amplifiers linearly amplifying the outputs and the optical sensors 65, 66 and 67 having the output amplifiers logarithmic-functionally amplifying the outputs, whereby the solid-state image pickup device 105 can be formed such that the both signals of the optical sensors 62, 63 and 64 having the output amplifiers linearly amplifying the outputs and the optical sensors 65, 66 and 67 having the output amplifiers logarithmic-functionally amplifying the outputs are read when the object moving speed is slow while the signals of the optical sensors 65, 66 and 67 having the output amplifiers logarithmic-functionally amplifying the outputs are read when the object moving speed is fast. Thus, images having high resolution can be obtained when the object moving speed is slow, while when the object moving speed is fast, read time is reduced since only the optical sensors 65, 66 and 67 having the output amplifiers logarithmic-functionally amplifying the outputs are read and hence images of the object moving at high moving speed can be taken.

According to the sixth embodiment, as hereinabove described, the solid-state image pickup device 105 comprises the optical sensors 62, 63 and 64 having the output amplifiers linearly amplifying the outputs and the optical sensors 65, 66 and 67 having the output amplifiers logarithmic-functionally amplifying the outputs, whereby the solid-state image pickup device 105 can be formed such that the both signals of the optical sensors 62, 63 and 64 having the output amplifiers linearly amplifying the outputs and the optical sensors 65, 66 and 67 having the output amplifiers logarithmic-functionally amplifying the outputs are read when low frame rate is required while the signals of the optical sensors 65, 66 and 67 having the output amplifiers logarithmic-functionally amplifying the outputs are read when the high frame rate is required. Thus, images having high resolution can be obtained when the low frame rate is required, while when the high low frame rate is required, read time is reduced since only the optical sensors 65, 66 and 67 having the output amplifiers logarithmic-functionally amplifying the outputs are read and hence images with the high frame rate can be taken.

### Seventh Embodiment

In a seventh embodiment, a structure of a solid-state image pickup device 106 including optical sensors comprising lenses having different photosensitivity and optical sensors comprising no lenses will be described with reference to FIGS. 1, 5, 8 and 18, dissimilarly to the aforementioned first to sixth embodiments.

In the structure of the solid-state image pickup device 106 according to the seventh embodiment, the high photosensitivity optical sensors 14, 24 and 34, the moderate photosensitivity optical sensors 15, 25 and 35 and the low photosensitivity optical sensors 16, 26 and 36 included in the solid-state image sensors 11, 21 and 31 of the solid-state image pickup devices according to the first, second and third embodiments shown in FIGS. 1, 5 and 8 are replaced with optical sensors 72 comprising the high photosensitivity lenses, optical sensors 73 comprising the low photosensitivity lenses and optical sensors 74 comprising no lenses described later.

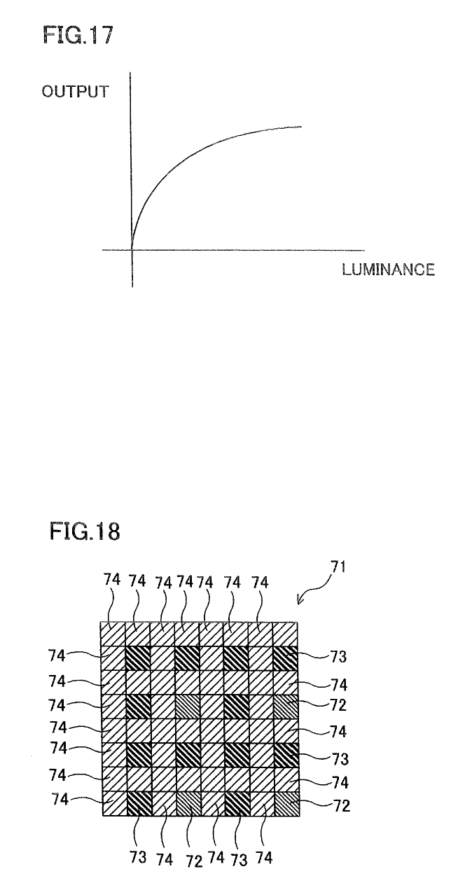

As shown in FIG. 18, the optical sensors 72 comprising the high photosensitivity lenses, the optical sensors 73 comprising the low photosensitivity lenses and the optical sensors 74 comprising no lenses, which are arranged on the solid-state image sensor 71 in the form of a matrix, are mixed. The optical sensors 72 comprising the high photosensitivity lenses, the optical sensors 73 comprising the low photosensitivity lenses and the optical sensors 74 comprising no lenses are examples of the “optical sensors” in the present invention. According to the seventh embodiment, the number of the arranged optical sensors 74 comprising no lenses is larger than the number of the arranged optical sensors 72 comprising the high photosensitivity lenses and the number of the optical sensors 73 comprising the low photosensitivity lenses is in the range between the number of the optical sensors 72 comprising the high photosensitivity lenses and the number of the optical sensors 74 comprising no lenses.

An operation of the solid-state image pickup device 106 according to the seventh embodiment of the present invention will be now described with reference to FIGS. 1, 5, 8 and 19.

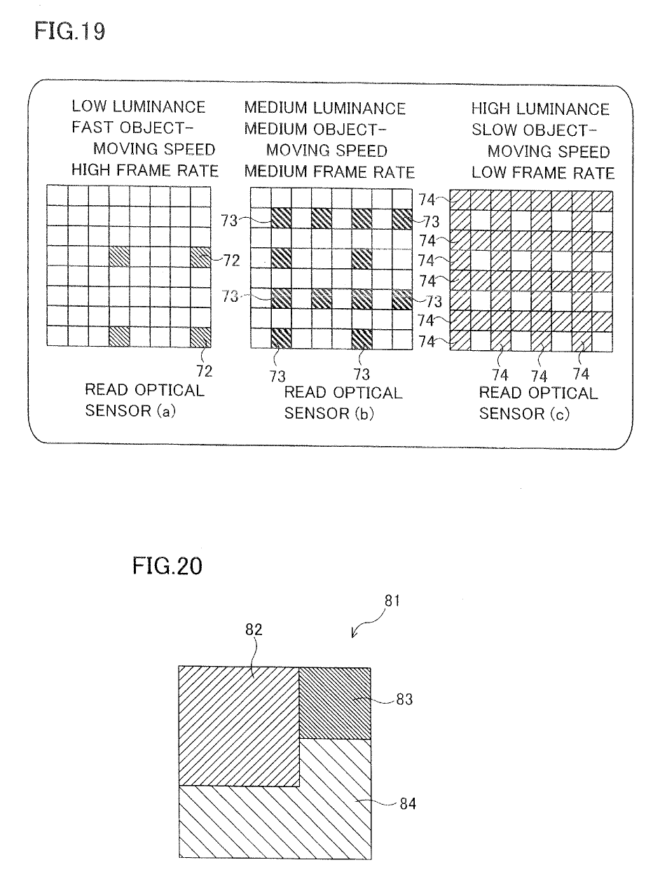

When the optical sensors to be read are different in response to luminance information of an object, a luminance information acquiring portion 18 in a digital signal processing portion 13 acquires luminance information of the object by calculating an average value of signals acquired when taking images on one frame (screen) prior to a frame of images to be now taken and inputted in the optical sensors of the one frame, as shown in FIG. 1. According to the seventh embodiment, the optical sensors 72 comprising the high photosensitivity lenses are read on the basis of a threshold value set by a user of the solid-state image pickup device 106 when the luminance is low (see the read optical sensors (a) in FIG. 19). When the luminance is moderate, the optical sensors 73 comprising the low photosensitivity lenses are read (see the read optical sensors (b) in FIG. 19). When the luminance is high, the optical sensors 74 comprising no lenses are read (see the read optical sensors (c) in FIG. 19).

When the optical sensors to be read are different in response to object moving speed information of the object, an object moving speed-information acquiring portion 28 in a digital signal processing portion 23 acquires object moving speed information of the object on the basis of signals acquired when taking images on a plurality of frames (screens) prior to a frame of images to be now taken and inputted in the optical sensors, as shown in FIG. 5. The optical sensors 72 comprising the high photosensitivity lenses are read on the basis of a threshold value set by the user of the solid-state image pickup device 106 when the object moving speed is fast (see the read optical sensors (a) in FIG. 19). When the object moving speed is moderate, the optical sensors 73 comprising the low photosensitivity lenses are read (see the read optical sensors (b) in FIG. 19). When the object moving speed is slow, the optical sensors 74 comprising no lenses are read (see the read optical sensors (c) in FIG. 19). The optical sensors 72 comprising the high photosensitivity lenses have higher photosensitivity than that of the optical sensors 74 comprising no lenses and hence exposure time can be reduced as compared with the optical sensors 74 comprising no lenses. The exposure time of the optical sensors 73 comprising the low photosensitivity lenses is in the range between the exposure time of the optical sensors 72 comprising the high photosensitivity lenses and the exposure time of the optical sensors 74 comprising no lenses.

When the optical sensors to be read are different in response to frame rate information, a frame rate information acquiring portion 38 in a digital signal processing portion 33 acquires frame rate information suitable for taking images of the object, as shown in FIG. 8. When high frame rate is required for taking images of the object, the optical sensors 72 comprising the high photosensitivity lenses are read (see the read optical sensors (a) in FIG. 19). When medium frame rate is required, the optical sensors 73 comprising the low photosensitivity lenses are read (see the read optical sensors (b) in FIG. 19). When low frame rate is required for taking images of the object, the optical sensors 74 comprising no lenses are read (see the read optical sensors (c) in FIG. 19).

According to the seventh embodiment, as hereinabove described, the solid-state image pickup device 106 comprises the optical sensors 72 comprising the high photosensitivity lenses, the optical sensors 73 comprising the low photosensitivity lenses and the optical sensors 74 comprising no lenses, whereby the solid-state image pickup device 106 can be formed such that signals of the optical sensors 72 comprising the high photosensitivity lenses are read when the luminance of the object is low, signals of the optical sensors 73 comprising the low photosensitivity lenses are read when the luminance of the object is moderate, and signals of the optical sensors 74 comprising no lenses are read when the luminance of the object is high. Thus, images having high photosensitivity can be obtained when the luminance of the object is low, images having moderate photosensitivity and resolution can be obtained when the luminance of the object is moderate, and images having high resolution can be obtained when the luminance of the object is high.

According to the seventh embodiment, as hereinabove described the solid-state image pickup device 106 comprises the optical sensors 72 comprising the high photosensitivity lenses, the optical sensors 73 comprising the low photosensitivity lenses and the optical sensors 74 comprising no lenses, whereby the solid-state image pickup device 106 can be formed such that the signals of the optical sensors 72 comprising the high photosensitivity lenses are read when the object moving speed is slow, the signals of the optical sensors 73 comprising the low photosensitivity lenses are read when the object moving speed is moderate, and the signals of the optical sensors 74 comprising no lenses are read when the object moving speed is slow. Thus, exposure time of the optical sensors 72 comprising the high photosensitivity lenses is reduced when the object moving speed is fast, and hence images of the object moving at high moving speed can be taken. When the object moving speed is moderate, images of the object moving at medium moving speed can be taken and images having medium resolution can be obtained. The number of the optical sensors 74 comprising no lenses is larger than the number of the optical sensors 72 comprising the high photosensitivity lenses and the number of the optical sensors 73 comprising the low photosensitivity lenses, whereby images having high resolution can be obtained when the object moving speed is slow.

According to the seventh embodiment, as hereinabove described the solid-state image pickup device 106 comprises the optical sensors 72 comprising the high photosensitivity lenses, the optical sensors 73 comprising the low photosensitivity lenses and the optical sensors 74 comprising no lenses, whereby the solid-state image pickup device 106 can be formed such that the signals of the optical sensors 72 comprising the high photosensitivity lenses are read when the high frame rate is required, the signals of the optical sensors 73 comprising the low photosensitivity lenses are read when the medium frame rate is required, and the signals of the optical sensors 74 comprising no lenses are read when the low frame rate is required. Thus, exposure time of the optical sensors 72 comprising the high photosensitivity lenses can be reduced and read time can be reduced since the number of the arranged optical sensors is small, whereby images with the high frame rate can be obtained when the high frame rate is required. When the object moving speed is moderate, images with the medium frame rate can be obtained and images having medium resolution can be obtained. The number of the optical sensors 74 comprising no lenses is larger than the number of the optical sensors 72 comprising the high photosensitivity lenses and the number of the optical sensors 73 comprising the low photosensitivity lenses, whereby images having high resolution can be obtained when the low frame rate is required.

### Eighth Embodiment

In an eighth embodiment, a structure of a solid-state image pickup device 107 acquiring luminance information per each optical sensor will be described with reference to FIGS. 1, 2, and 20, dissimilarly to the aforementioned first to seventh embodiments.

The structure of the solid-state image pickup device 107 according to the eighth embodiment and arrangement of optical sensors 14, 15 and 16 having different photosensitivity are similar to those of the solid-state image pickup device according to the first embodiment shown in FIGS. 1 and 2.

An operation of the solid-state image pickup device 107 according to the eighth embodiment of the present invention will be now described with reference to FIGS. 1, 20, and 21.

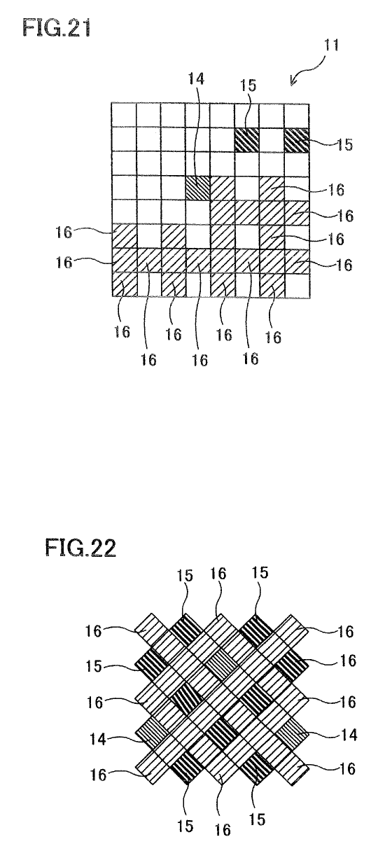

As shown in FIG. 1, a luminance information acquiring portion 18 in a digital signal processing portion 13 acquires luminance information of an object on the basis of signals acquired when taking images on one frame (screen) prior to a frame of images to be now taken and inputted in the respective optical sensors. According to the eighth embodiment, on the basis of a threshold value set by a user of the solid-state image pickup device 107, the high photosensitivity optical sensor 14 is read (see FIG. 21) on a low luminance region 82 (see FIG. 20) on a solid-state image sensor 81, the moderate photosensitivity optical sensors 15 are read (see FIG. 21) on a medium luminance region 83 (see FIG. 20) and the low photosensitivity optical sensors 16 are read (see FIG. 20) on a high luminance region 84 (see FIG. 20). On a region with no optical sensor having sufficient prescribed photosensitivity required for color processing, images can be obtained by presuming the amount of signals inputted in optical sensors existing in the vicinity, having photosensitivity different from the optical sensors having the prescribed photosensitivity.

According to the eighth embodiment, as hereinabove described, the object information is acquired for respective optical sensors 14, 15 and 16 and the signals of the optical sensors having the prescribed photosensitivity are read in response to the object information, whereby the signals of the optical sensors 14, 15 and 16 having optimum prescribed photosensitivity can be read for respective regions on the solid-state image sensor 81 and hence images having better quality can be obtained as compared with a case where the solid-state image pickup device formed such that signals of only one type of the optical sensors are read. For example, signals of the optical sensors 14, 15 and 16 having optimum photosensitivity are read for respective regions set on the solid-state image sensor 11 according to object information regarding luminance, whereby signals of a plurality of types of the optical sensors are read on one screen and hence the dynamic range of the solid-state image pickup device 107 can be broadened. Optimum signals are read employing object moving speed information or frame rate information as object information, whereby the signals of the plurality of types of the optical sensors are read in the one screen, and hence images with high and low frame rate or images by long and short exposure time having better quality can be obtained in response to the object information for the respective regions in the one screen.

Although the present invention has been described and illustrated in detail, it is clearly understood that the same is by way of illustration and example only and is not to be taken by way of limitation, the spirit and scope of the present invention being limited only by the terms of the appended claims.

For example, while the digital signal processing portion acquires the object information in each of the aforementioned first to eighth embodiments, the present invention is not restricted to this but the analog signal processing portion may be alternatively acquire the object information.

While the high photosensitivity optical sensors, the moderate photosensitivity optical sensors and the low photosensitivity optical sensors are mounted with the color filters in each of the aforementioned first to third embodiments and the seventh and eighth embodiments, the present invention is not restricted to this but the high photosensitivity optical sensors, the moderate photosensitivity optical sensors and the low photosensitivity optical sensors may be mounted with primary color filters or complementary color filters.

While the signals of the one type of the optical sensors among the plurality of types of the optical sensors are read in each of the aforementioned first to seventh embodiments, the present invention is not restricted to this but signals of two or more types of the optical sensors may be alternatively read.

While the plurality of types of the optical sensors are arranged in directions horizontal and perpendicular to the solid-state image pickup device in the form of a matrix in each of the aforementioned first to eighth embodiments, the present invention is not restricted to this but arrangement obtained by rotating the optical sensors by about 45° with respect to the solid-state image pickup device as in a modification shown in FIG. 22, which improves resolution in horizontal and vertical directions, may alternatively employed.

What is claimed is:

1. A solid-state image pickup device comprising a plurality of optical sensors having different photosensitivity, wherein
signals of said optical sensors having prescribed photosensitivity are read in response to object information.

2. The solid-state image pickup device according to claim 1, wherein
said object information is at least one of luminance of an object, object moving speed of the object, and the number of screens renewed per unit time suitable for taking images of the object.

3. The solid-state image pickup device according to claim 2, wherein
said object information is obtained from a screen prior to a screen of images to be now taken.

4. The solid-state image pickup device according to claim 1, wherein
the photosensitivity of said optical sensors having different photosensitivity differs depending on at least any of presence/absence of electron multiplication functions of said optical sensors, sizes of said optical sensors, characteristics of output amplifiers amplifying output signals of said optical sensors and variety of lenses included in said optical sensors.

5. The solid-state image pickup device according to claim 4, wherein
said optical sensors having different photosensitivity include optical sensors having said electron multiplication functions and optical sensors having no electron multiplication functions, and
said optical sensors having said electron multiplication functions are read when luminance is lower than prescribed luminance, object moving speed is faster than prescribed speed or the number of screens renewed per unit time is larger than prescribed screen number, while said optical sensors having said electron multiplication functions which are turned off and said optical sensors having no electron multiplication functions are read when luminance is higher than said prescribed luminance, object moving speed is slower than said prescribed or the number of screens renewed per unit time is smaller than said prescribed screen number.

6. The solid-state image pickup device according to claim 5, wherein
the number of said optical sensors having no electron multiplication functions is larger than the number of said optical sensors having said electron multiplication functions.

7. The solid-state image pickup device according to claim 4, wherein
said optical sensors having different photosensitivity include first optical sensors, second optical sensors with surface areas larger than those of said first optical sensors and third optical sensors with surface areas larger than those of said second optical sensors, and
said third optical sensors are read when luminance is lower than prescribed first luminance, object moving speed is faster than prescribed first speed or the number of screens renewed per unit time is larger than prescribed first screen number, said third optical sensors are read when luminance is higher than prescribed second luminance, object moving speed is slower than prescribed second speed or the number of screens renewed per unit time is smaller than prescribed second screen number, and said second optical sensors are read when luminance is in the range between said first luminance and said second luminance, object moving speed is in the range between said first speed and said second speed or the number of screens renewed per unit time is in the range between said first screen number and said second screen number.

8. The solid-state image pickup device according to claim 7, wherein
the number of said third optical sensors is larger than that of said first optical sensors, and the number of said second optical sensors is in the range between the number of said third optical sensor and the number of said first optical sensors.

9. The solid-state image pickup device according to claim 4, wherein
said optical sensors having different photosensitivity include optical sensors having output amplifiers linearly amplifying outputs and optical sensors having output amplifiers logarithmic-functionally amplifying outputs, and
said optical sensors having said output amplifiers linearly amplifying the outputs and said optical sensors having said output amplifiers logarithmic-functionally amplifying the outputs are read when luminance is lower than prescribed luminance, object moving speed is slower than prescribed speed or the number of screens renewed per unit time is smaller than prescribed screen number, said optical sensors having said output amplifiers logarithmic-functionally amplifying the outputs are read when luminance is higher than said prescribed luminance, object moving speed is faster than said prescribed speed or the number of screens renewed per unit time is larger than said prescribed screen number.

10. The solid-state image pickup device according to claim 4, wherein
said optical sensors having different photosensitivity include optical sensors comprising high photosensitivity lenses, optical sensors comprising low photosensitivity lenses having photosensitivity lower than that of said high photosensitivity lenses and optical sensors comprising no lenses, and
said optical sensors comprising said high photosensitivity lenses are read when luminance is lower than prescribed first luminance, object moving speed is faster than prescribed first speed or the number of screens renewed per unit time is larger than prescribed first screen number, said optical sensors comprising no lenses are read when luminance is higher than prescribed second luminance object moving speed is slower than prescribed second speed or the number of screens renewed per unit time is smaller than prescribed second screen number, and said optical sensors comprising said low photosensitivity lenses when luminance is in the range between said prescribed first luminance and said prescribed second luminance, object moving speed is in the range between said prescribed first speed and said prescribed second speed or the number of screens renewed per unit time is in the range between said prescribed first screen number and said prescribed second screen number.

11. The solid-state image pickup device according to claim 1, wherein
the respective numbers of said optical sensors having different photosensitivity are different, and signals of said optical sensors having different prescribed photosensitivity are read in response to said object information.

12. The solid-state image pickup device according to claim 1, wherein
a solid-state image sensor constituted by said optical sensors having different photosensitivity is so formed such that said optical sensors having prescribed photosensitivity are read for respective regions set on said solid-state image pickup device according to said object information.

13. The solid-state image pickup device according to claim 12, wherein
said optical sensors having different photosensitivity include high photosensitivity optical sensors, moderate photosensitivity optical sensors having photosensitivity lower than said high photosensitivity optical sensors, and low photosensitivity optical sensors having photosensitivity lower than said moderate photosensitivity optical sensors, and
said high photosensitivity optical sensors are read on a region having luminance lower than prescribed first luminance on said solid-state image pickup device, said low photosensitivity optical sensors are read on a region having luminance higher than prescribed second luminance on said solid-state image pickup device, and said moderate photosensitivity optical sensors are read on a region having luminance between said prescribed first luminance and said prescribed second luminance on said solid-state image pickup device.

14. The solid-state image pickup device according to claim 1, wherein
said plurality of optical sensors include fourth optical sensors, fifth optical sensors having photosensitivity higher than said fourth optical sensors, and sixth optical sensors having photosensitivity higher than said fifth optical sensors, and
signals of at least one type of said optical sensors among said fourth optical sensors, said fifth optical sensors and said sixth optical sensors are read in response to said object information.

15. The solid-state image pickup device according to claim 14, wherein
said sixth optical sensors are read when luminance is lower than prescribed first luminance, object moving speed is faster than prescribed first speed or the number of screens renewed per unit time is larger than prescribed first screen number, said fourth optical sensors are read when luminance is higher than prescribed second luminance, object moving speed is slower than prescribed second speed or the number of screens renewed per unit time is smaller than prescribed second screen number, and said fifth optical sensors are read when luminance is in the range between said first luminance and said second luminance, object moving speed is in the range between said first speed and said second speed or the number of screens renewed per unit time is in the range between said first screen number and said second screen number.

16. The solid-state image pickup device according to claim 1, wherein
a threshold value of said optical sensors to be read in response to said object information is manually set.

17. The solid-state image pickup device according to claim 1, wherein
said plurality of optical sensors are mounted with red, green and blue color filters.

18. The solid-state image pickup device according to claim 1, wherein
said plurality of optical sensors having different photosensitivity, which are arranged in the form of a matrix, are mixed.

19. The solid-state image pickup device according to claim 1, wherein
said plurality of optical sensors having different photosensitivity are arranged along a direction intersecting with a horizontal or vertical direction.

20. A solid-state image pickup device comprising a plurality of optical sensors having different photosensitivity, wherein
signals of said optical sensors having photosensitivity in response to object information are read from among said plurality of photosensitivity.
